(19) United States
(12) Patent Application Publication
(10) Pub. No.: US 2026/0213701 A1
(43) Pub. Date: Jul. 23, 2026

(54) SOLAR TRACKER INTERFACE

(71) Applicant: APA SOLAR, LLC, Ridgeville Corners, OH (US)

(72) Inventors: Josh Von Deylen, Bryan, OH (US); Joseph Von Deylen, Whitehouse, OH (US); Richard Alan Roth, Archbold, OH (US); Shawn Jeremy Ramey, Ney, OH (US); Erik Steven Shinabery, Bryan, OH (US); Brandon Lambert, Napoleon, OH (US)

(21) Appl. No.: 19/455,309

(22) Filed: Jan. 21, 2026

Related U.S. Application Data
(60) Provisional application No. 63/748,008, filed on Jan. 22, 2025.

(51) Int. Cl. H02S 20/32; F24S 30/425; F24S 30/00

(52) U.S. Cl. CPC H02S 20/32; F24S 30/425; F24S 2030/12

(57) ABSTRACT

An interface for a solar tracking system is disclosed. The interface can couple a bearing housing assembly to a foundation member and can include a pivot plate and a pair of brackets. The pivot plate can include a top panel configured to receive the bearing housing assembly and a pair of edge panels extending from lateral edges of the top panel. Each bracket can include a central panel, a mounting projection extending from a longitudinal end of the central panel, and a pair of foundation plates extending from lateral edges of the central panel. The mounting projection can be attached to a corresponding edge panel of the pivot plate. The pair of foundation plates can receive the foundation member therebetween. One foundation plate can include an alignment lip and the other foundation plate can include a planar edge.

### CROSS-REFERENCE TO RELATED APPLICATIONS

This application claims the benefit of U.S. Provisional Application No. 63/748,008, filed on January 22, 2025. The entire disclosure of the above application is incorporated herein by reference.

### FIELD

The present technology relates to mechanical interface assemblies for solar tracking systems and, more particularly, to a solar tracking interface for single-axis solar tracker installations.

### INTRODUCTION

This section provides background information related to the present disclosure which is not necessarily prior art.

A solar tracking system, particularly a single-axis tracking system, enables adjustment of an angle of a photovoltaic module relative to the sun in utility-scale power installations. The single-axis tracking system is capable of supporting varying numbers of photovoltaic modules on its shafts. For example, supporting up to 180 modules on a single shaft generates substantial wind loads, which can adversely affect system performance. The single-axis tracking system therefore faces engineering challenges related to module support, structural stability, and wind resistance.

The single-axis tracking system may employ a motor positioned at portion of the tracker table, with the shaft extending longitudinally therefrom. This configuration can give rise to certain performance issues. Manufacturing tolerances, installation variances, and torsional loads from module weight can induce rotational deflection in the shaft, thereby making it difficult to maintain uniform tilt angles across all modules. Wind forces can further exacerbate structural challenges in single-axis tracking systems, as wind tunnel analysis has demonstrated non-uniform pressure distribution across photovoltaic modules, resulting in a pressure gradient that generates torsional loads along the shaft, where peak intensity can end up being positioned adjacent to the drive system.

At shallow tilt angles, single-axis trackers can also be susceptible to aeroelastic instability. This structural phenomenon, also referred to as torsional divergence or “galloping,” occurs when leading-edge vortices generate oscillating aerodynamic forces. These forces can present issues with structural integrity if wind speeds exceed certain thresholds. The modal frequency of the structure, which depends on unsupported shaft length, can directly affect the risk of this instability.

Accordingly, there is a need for a solar tracking interface that can effectively address the challenges of module loads, non-uniform wind forces, and structural instability. Ideally, such a solar tracking interface would provide enhanced torsional stability, more precise angle control across the entire array, and improved resistance to aeroelastic effects, while remaining cost-effective for utility-scale installations.

### SUMMARY

In concordance with the instant disclosure, a solar tracking interface that provides enhanced torsional stability, increased angle control across the entire solar array, and improved resistance to aeroelastic effects, while remaining cost-effective for utility-scale installations, has surprisingly been discovered. The present technology includes articles of manufacture, systems, and processes that relate to mechanical interface assemblies for solar tracking systems and, more particularly, to a solar tracking interface for single-axis solar tracker installations.

In certain embodiments, a solar tracker interface is provided. The solar tracker interface can be configured to receive a bearing housing assembly and a foundation member. The solar tracker interface can include a pivot plate and a pair of brackets. The pivot plate can include a top panel that can receive the bearing housing assembly. The pivot plate can include a pair of edge panels that can extend from lateral edges of the top panel. Each bracket can include a central panel, a mounting projection extending from a longitudinal end of the central panel, and a pair of foundation plates extending from lateral edges of the central panel. The mounting projection can be attached to a corresponding edge panel of the pivot plate, and the pair of foundation plates can receive the foundation member therebetween, with one foundation plate including an alignment lip and the other including a planar edge. The alignment lip can provide a planar offset from a remainder of the foundation plate.

In certain embodiments, a solar tracker interface is provided. The solar tracker interface can include the pivot plate and brackets as described herein, wherein structural relationships, aperture configurations, and angular relationships between components can be predefined. The pivot plate and brackets can each form U-shaped cross-sections, and multiple apertures of differing shapes can be provided to accommodate adjustment, alignment, and coupling. Engagement features associated with selected apertures can militate against undesired rotation, and a mounting projection can define a controlled range of angular adjustment relative to the pivot plate.

In certain embodiments, a solar tracking system is provided. The solar tracking system can include a bearing housing assembly, a pair of foundation members, and the pivot plate and brackets as described herein. The pivot plate can support the bearing housing assembly, and each bracket can couple the pivot plate to a respective foundation member. An alignment lip of one bracket can be coupled to a planar edge of the other bracket to facilitate alignment between the foundation members.

In certain embodiments, a method of installing a solar tracking system is provided. The method of installing a solar tracking system can include providing a solar tracking system as described herein. The method can include adjusting an angular position of each foundation member relative to a corresponding pair of foundation plates. The method can adjusting an angular position of the pivot plate relative to a mounting projection of each bracket.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of a solar tracker interface with a bearing housing assembly and a pair of foundation members coupled thereto, according to an embodiment of the present disclosure;

FIG. 2 is a bottom perspective view of the solar tracker interface, according to the embodiment shown in FIG. 1;

FIG. 3 is a front elevational view of the solar tracker interface, according to the embodiment shown in FIG. 1;

FIG. 4 is a rear elevational view of the solar tracker interface, according to the embodiment shown in FIG. 1;

FIG. 5 is a right-side elevational view of the solar tracker interface, according to the embodiment shown in FIG. 1;

FIG. 6 is a left-side elevational view of the solar tracker interface, according to the embodiment shown in FIG. 1;

FIG. 7 is a top plan view of the solar tracker interface, according to the embodiment shown in FIG. 1;

FIG. 8 is a bottom plan view of the solar tracker interface, according to the embodiment shown in FIG. 1;

FIG. 9 is a top perspective view of a pivot plate of the solar tracker interface, according to the embodiment shown in FIG. 1;

FIG. 10 is a front perspective view of a bracket of the solar tracker interface, according to the embodiment shown in FIG. 1;

FIG. 11 is a rear perspective view of the bracket of the solar tracker interface, according to the embodiment shown in FIG. 10;

FIG. 12 is a top plan view of the bracket of the solar tracker interface, according to the embodiment shown in FIG. 11; and

FIG. 13 is a flow chart illustrating a method of installing a solar tracker interface, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X may have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology can improve a single-axis solar tracking system by providing a solar tracker interface configured to receive a bearing housing assembly that can provide enhanced torsional stability, improved angular control across an array of solar panels, and increased resistance to aeroelastic effects, while remaining cost-effective for utility-scale solar panel installations. The solar tracker interface can securely anchor a rotating shaft that defines a central axis for rotational movement of one or more solar panels by directly accommodating one or more bearing housing assemblies coupled to the rotating shaft. Direct attachment of the bearing housing assembly to the solar tracker interface can simplify installation by reducing reliance on additional brackets and fasteners. This reduction in component count can militate against potential failure points, distribute loads more efficiently, and enhance overall solar tracker system reliability under dynamic loading conditions such as wind-induced forces.

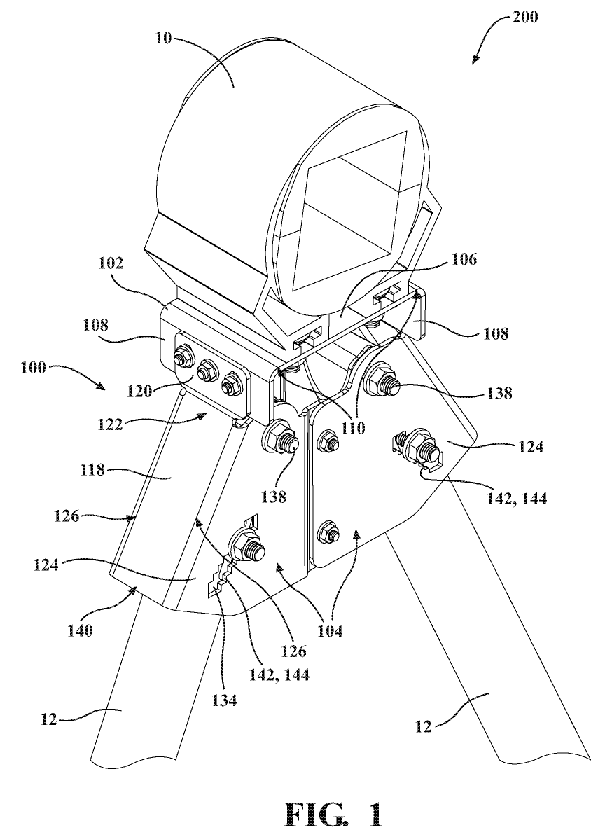

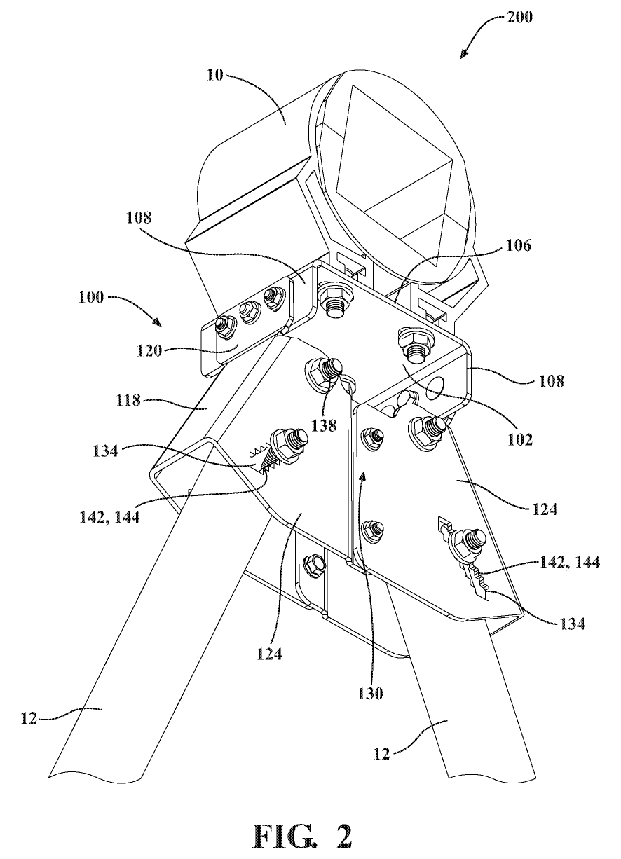

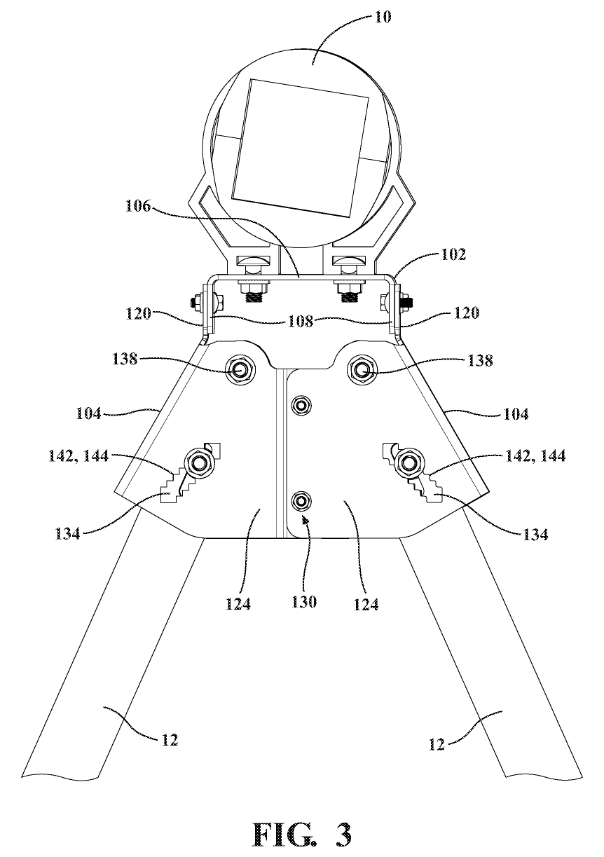

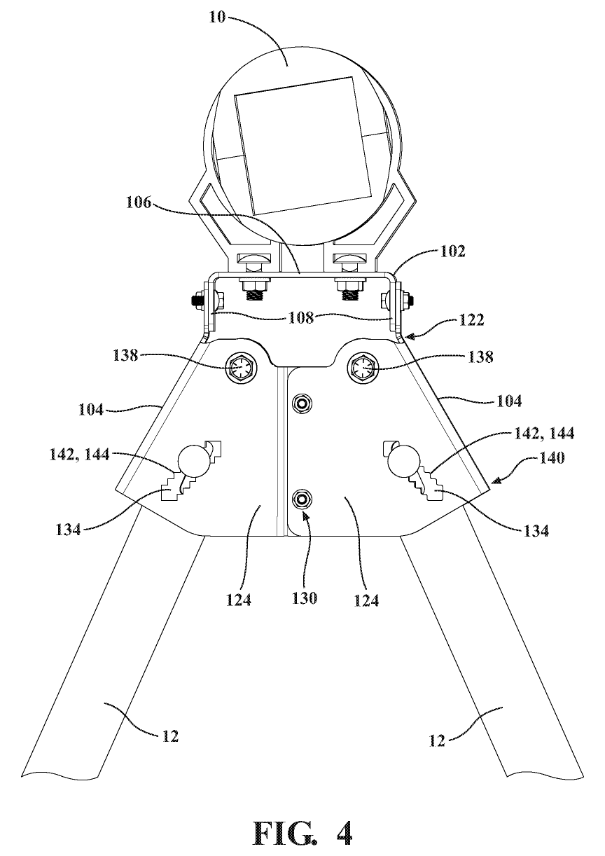

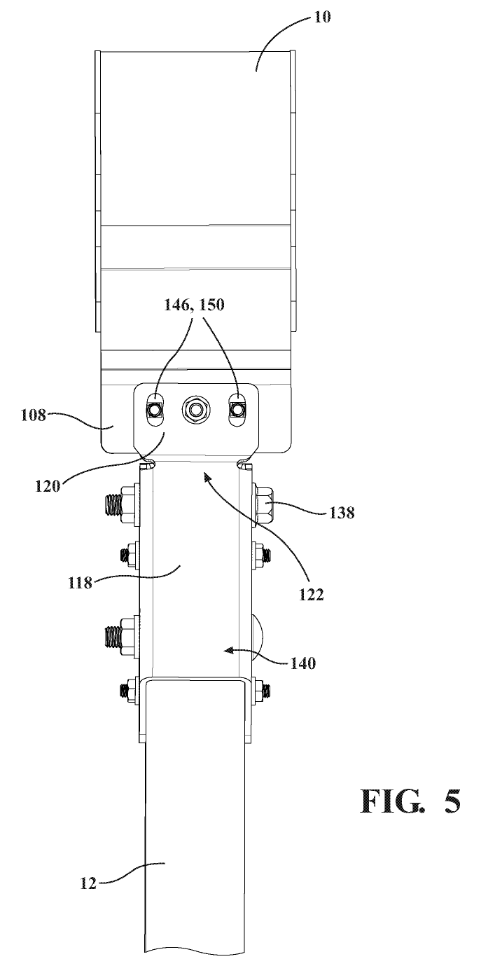

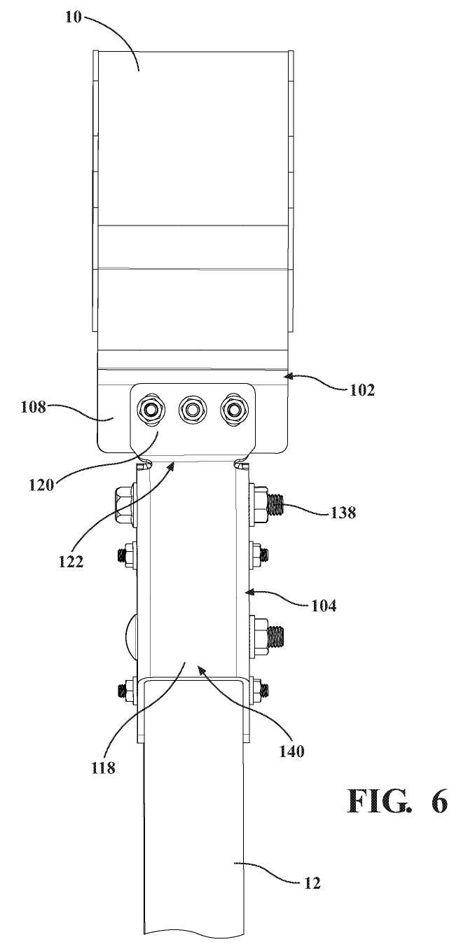

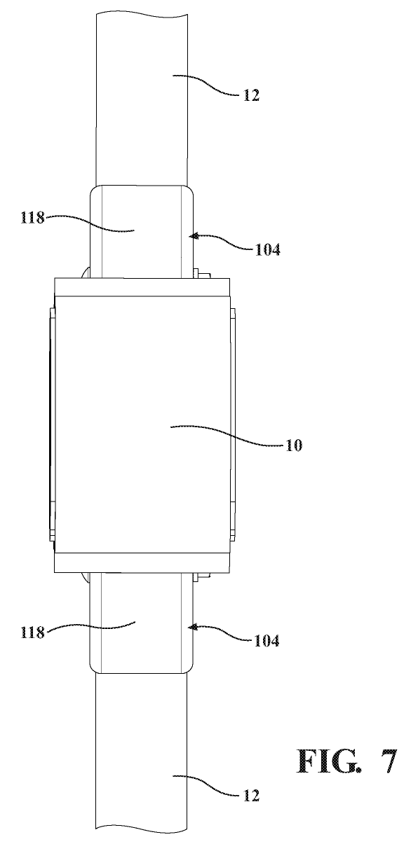

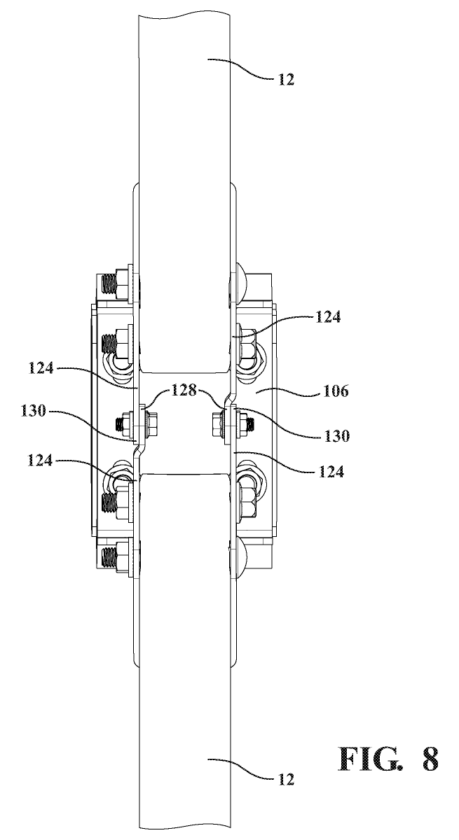

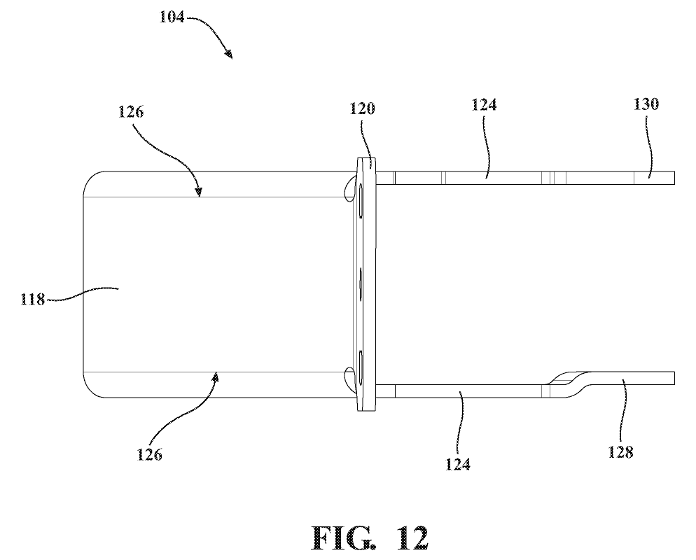

With reference to FIGS. 1-13, embodiments of a solar tracker interface 100, a solar tracking system 200, and a method 300 of installing a solar tracker interface 100 are provided and described herein. The solar tracker interface 100 can be utilized with certain solar panel foundation systems. For example, reference is made to U.S. Patent No. 12,378,744, titled SOLAR TRACKER INTERFACE, issued on August 5, 2025, the entire disclosure of which is incorporated herein by reference. U.S. Patent No. 12,378,744 describes a solar panel foundation system and method of installation. The solar panel foundation system can include a plurality of brackets, a plurality of braces, a plurality of members, and a plurality of piles which can serve as a basis for in employing the interfaces, systems, and methods detailed in this document. It should be appreciated that the solar tracker interface 100 of the present disclosure can be utilized with other solar panel foundation systems within the scope of the present disclosure.

With reference to FIGS. 1-8, in certain embodiments, the solar tracker interface 100 can be configured to receive a bearing housing assembly 10 and a foundation member 12. The solar tracker interface 100 can include a pivot plate 102 and a pair of brackets 104. The pivot plate 102 can provide an interface between the bearing housing assembly 10 and the pair of brackets 104 for mounting the rotatable shaft (not shown). The pair of brackets 104 can provide an interface between the pivot plate 102 and the foundation member 12. The pivot plate 102 and the pair of brackets 104 can cooperate to support adjustment and alignment of the solar tracker interface 100 relative to the bearing housing assembly 10 and the foundation member 12. Advantageously, the pivot plate 102 can enable direct integration between the bearing housing assembly 10 and the foundation members 12 while minimizing the number of separate components required for installation. The pivot plate 102 can therefore reduce potential failure points while maintaining structural integrity of the solar tracking system 200.

With reference to FIGS. 1-6 and 9, in certain embodiments, the pivot plate 102 of the solar tracker interface 100 can include a top panel 106. The top panel 106 can be configured to receive the bearing housing assembly 10. The pivot plate 102 can include a pair of edge panels 108, where the edge panels 108 can also be referred to as side panels. The pair of edge panels 108 can extend from lateral edges 110 of the top panel 106. The pair of edge panels 108 can each provide attachment locations for the pair of brackets 104. It should be understood that the pair of edge panels 108 can be formed integrally with the top panel 106 to provide a single-piece pivot plate 102. Forming the pivot plate 102 as a single piece can reduce the number of components required for installation and can militate against potential failure points, while maintaining structural integrity of the system. The material utilized for the pivot plate 102 can be metal or another suitable material selected based on application-specific considerations, such as load-bearing capacity, environmental resistance, and ease of maintenance. In addition, a coating or finish, such as a galvanized finish, paint, epoxy, or another suitable coating, can be applied to the pivot plate 102 to enhance environmental resistance and facilitate maintenance.

In certain embodiments, the pair of edge panels 108 can extend substantially parallel to each other. This parallel arrangement can facilitate symmetric loading of the pivot plate 102 and allow for angular adjustment, as further described herein. The pair of edge panels 108 can extend substantially perpendicular to the top panel 106. The perpendicular arrangement can increase resistance to bending. The top panel 106 and the pair of edge panels 108 can form a U-shaped cross-section. The U-shaped cross-section can enhance stiffness of the pivot plate 102.

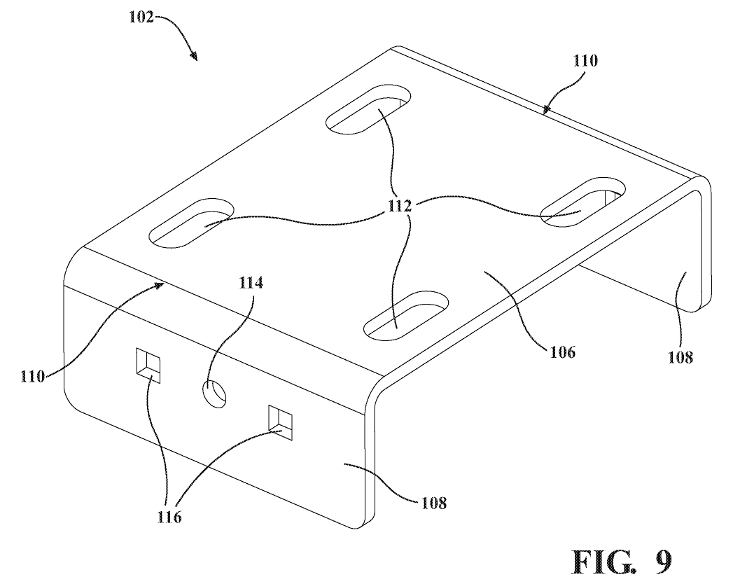

With reference to FIG. 9, in certain embodiments, the pivot plate 102 can include a plurality of first apertures 112, a plurality of second apertures 114, and a plurality of third apertures 116. The apertures 112, 114, 116 can be used for fastening and alignment of the pivot plate 102 to the bearing housing assembly 10 and the pair of brackets 104. The plurality of first apertures 112 can be disposed in the top panel 106. Placement in the top panel 106 can allow coupling of the bearing housing assembly 12 to the pivot plate 102. The first apertures 112 can accommodate fasteners extending through the top panel 106. Each first aperture of the plurality of first apertures 112 can be elongated. For example, each first aperture of the plurality of first apertures 112 can be stadium shaped. The elongated shape can facilitate alignment during assembly and can permit positional adjustment of the bearing housing assembly 10 along a lateral axis of the pivot plate 102.

In certain embodiments, the plurality of second apertures 114 and plurality of third apertures 116 can be disposed in the pair of edge panels 108. Each of the edge panels 108 can include the plurality of second apertures 114 and plurality of third apertures 116. The plurality of second apertures 114 and plurality of third apertures 116 can receive fasteners configured to couple the pivot plate 102 to each respective bracket of the pair of brackets 104. Each second aperture of the plurality of second apertures 114 can be round. The round shape can provide a point of rotation for the pivot plate 102 to rotate about. The round shape can allow controlled pivoting of the pivot plate 102 relative to the pair of brackets 104, enabling angular adjustment during installation without binding. Each third aperture of the plurality of third apertures 116 can be square. The square shape can cooperate with fasteners such as carriage bolts. The square shape can resist rotation of the fastener within each third aperture 116, thereby ensuring secure and stable attachment of the pivot plate 102 to the pair of brackets 104 under operational loads.

With reference to FIGS. 1-6 and 10-12, in certain embodiments, the pair of brackets 104 of the solar tracker interface 100 can each include a central panel 118. Each bracket 104 can include a mounting projection 120. The mounting projection 120 can extend from a longitudinal end 122 of the central panel 118. The mounting projection 120 can be configured to be attached to one of the edge panels 108 of the pivot plate 102. The mounting projection 120 can permit relative angular positioning between the pivot plate 102 and the bracket 104, as further described herein with reference to mounting apertures of the mounting projection 120.

In certain embodiments, each bracket 104 can include a pair of foundation plates 124, which can also be referred to as a pair of major side panels. The foundation plates 124 can be spaced from one another thereby defining a receiving region for the foundation member 12. The pair of foundation plates 124 can extend from lateral edges 126 of the central panel 118. The pair of foundation plates 124 can extend substantially parallel to each other. The pair of foundation plates 124 can extend substantially perpendicular to the central panel 118. The central panel 118 and the pair of foundation plates 124 can thereby form a U-shaped cross-section. The U-shaped cross-section can enhance strength of the brackets 104 and resist deformation. The foundation member 12 can be positioned between opposing foundation plates 124. Fasteners can be used to couple the foundation member 12 to the foundation plates 124. It should be understood that the foundation plates 124 can be formed integrally with the central panel 118 to provide a single-piece bracket 104. Forming the bracket 104 as a single piece can reduce the number of components required for installation and can militate against potential failure points, while maintaining structural integrity of the system. The material utilized for the pair brackets 104 can be metal or another suitable material selected based on application-specific considerations, such as load-bearing capacity, environmental resistance, and ease of maintenance. In addition, a coating or finish, such as a galvanized finish, paint, epoxy, or another suitable coating, can be applied to the pair of brackets 104 to enhance environmental resistance and facilitate maintenance.

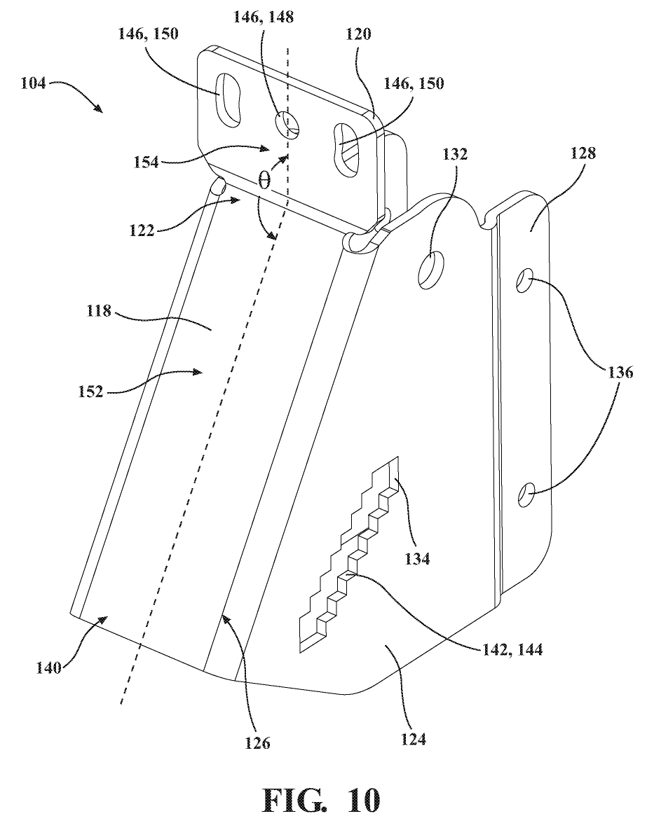

With reference to FIGS. 10-12, in certain embodiments, one of the foundation plates 124 can include an alignment lip 128, and the other one of the foundation plates 124 can include a planar edge 130. The alignment lip 128 can provide a planar offset from a remainder of the foundation plate 124. The alignment lip 128 and the planar edge 130 can cooperate to promote alignment between adjacent components. This can include where one bracket 104 faces another bracket 104. The alignment lip 128 of one of the brackets 104 can be configured to nest alongside the planar edge 130 of the other bracket 104. Advantageously, the alignment lips 128 can enhance structural integrity by creating an overlapping connection between the foundation plates 124 of the brackets 104. The overlapping arrangement can provide additional structural support and rigidity to the assembled solar tracker interface 100 by distributing loads across both brackets 104 through their nested connection. This nested configuration can further promote proper alignment of corresponding fastening apertures, thereby facilitating assembly and reducing the likelihood of misalignment during installation.

With reference to FIGS. 10-12, in certain embodiments, the pair of brackets 104 can include a plurality of fourth apertures 132, a plurality of fifth apertures 134, and a plurality of sixth apertures 136, which can also be referred to as mounting apertures, adjustment apertures, and fastening apertures, respectively. Each plurality of fourth, fifth, and sixth apertures 132, 134, 136 can support coupling, adjustment, and alignment of the pair of brackets 104 to the foundation members 12 and the pivot plate 102.

The plurality of fourth apertures 132 can be disposed in the pair of foundation plates 124 adjacent to the longitudinal end 122 of the central panel 118. The fourth apertures 132 can be configured to receive a first fastener 138 extending through one aperture of the plurality of fourth apertures 132 and a corresponding aperture (not shown) of the foundation member 12. The one aperture of the plurality of fourth apertures 132 can permit relative rotation of the foundation member 12 about the first fastener 138. This configuration can allow angular adjustment of the foundation member 12 during installation.

The plurality of fifth apertures 134 can be disposed in the pair of foundation plates 124 adjacent another longitudinal end 140 of the central panel 118. The fifth apertures 134 can be spaced apart from the fourth apertures 132. The fifth apertures 134 can be configured to allow adjustment of the angular orientation of the foundation member 12. Each fifth aperture of the plurality of fifth apertures 134 can be elongated and can include a plurality of engagement features 142. The engagement features 142 can be configured to militate against rotation of the foundation member 12 about the first fastener 138. The engagement features can cooperate with fasteners to militate against rotation of the foundation member 12 about the first fastener 138. For example, the plurality of engagement features 142 can include teeth 144 formed along a portion of each fifth aperture of the plurality of fifth apertures 134. The teeth 144 can engage corresponding surfaces of a fastener.

Each fifth aperture 134 can have a longitudinal axis that can be non-parallel to the lateral edges 126 of the central panel 118. The non-parallel orientation can define an adjustment path for angular adjustment of the foundation member 12 with respect to the first fastener 138. This angled adjustment path can permit incremental changes in angular position as the foundation member 12 is moved relative to the fifth aperture 134.

The plurality of sixth apertures 136 can be disposed in the pair of foundation plates 124 and can be configured to couple the pair of foundation plates 124 when fasteners extend through aligned sixth apertures 136 of respective brackets 104. The plurality of sixth apertures 136 can be disposed in the alignment lip 128 and the planar edge 130.

For a given bracket 104, one of the foundation plates 124 can include the alignment lip 128, while the other foundation plate 124 can be formed without the alignment lip 128. The plurality of sixth apertures 136 can be disposed in the alignment lip 128 of the foundation plate 124 of the bracket 104. The plurality of sixth apertures 136 can also be disposed in the foundation plate 124 of the bracket 104 that does not include the alignment lip 128, such that, when the foundation plate 124 of one bracket 104 nests above the alignment lip 128 of another bracket 104, the respective sixth apertures 136 can be aligned. Alignment of the sixth apertures 136 can permit fasteners to extend through overlapping foundation plates 124 of the nested brackets 104, thereby coupling the brackets 104 together.

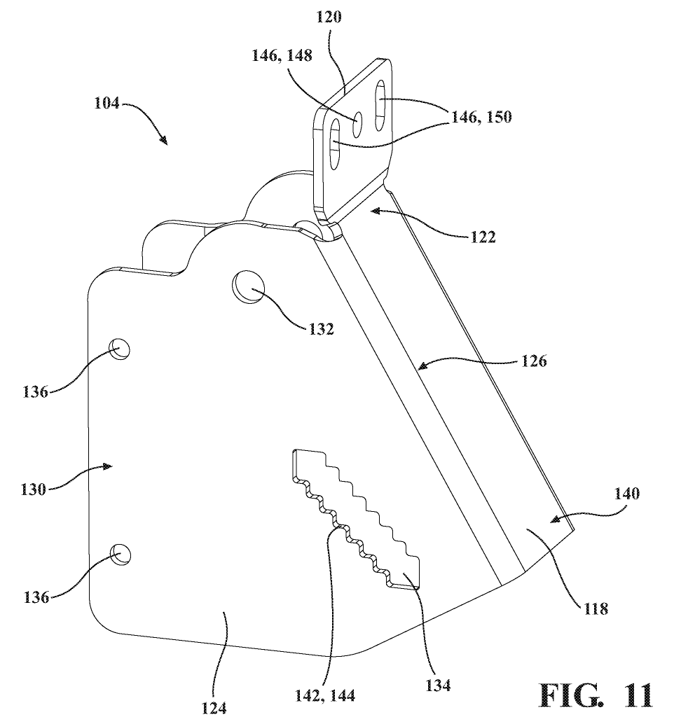

With reference to FIGS. 10-11, in certain embodiments, the mounting projection 120 can include a plurality of mounting apertures 146. The mounting apertures 146 can receive fasteners for coupling the mounting projection 120 to the pivot plate 102. The mounting apertures 146 can support pivoting and adjustment of the pivot plate 102 with respect to the mounting projection 120. The plurality of mounting apertures 146 can include a pivot aperture 148. The pivot aperture 148 can define a rotational axis about which the pivot plate 102 can rotate.

The plurality of mounting apertures 146 can include a pair of adjustment apertures 150. The pair of adjustment apertures 150 can cooperate to define a range of rotational travel of the pivot plate 102 relative to the mounting projection 120. The pivot aperture 148 and the pair of adjustment apertures 150 can form a linear array. The adjustment apertures 150 can be disposed on opposite sides of the pivot aperture 148 along the linear array. Each adjustment aperture of the pair of adjustment apertures can have a kidney-shaped profile. The kidney-shaped profile can allow the pivot plate to move through a fixed arc.

In certain embodiments, a plane 152 of the central panel 118 and a plane 154 of the mounting projection 120 can form an obtuse angle 𝜃, as shown in FIG. 10. The obtuse angle 𝜃 can orient the mounting projection 120 relative to the central panel 118 to accommodate installation geometry of the solar tracking system 200.

With reference to FIGS. 1-8, in certain embodiments, a solar tracking system 200 is provided. The solar tracking system 200 can be configured to support rotational tracking of a solar panel (not shown) relative to a surface. The solar tracking system 200 can incorporate the solar tracker interface 100 described hereinabove to provide structural support and alignment functionality. The solar tracking system 200 can include a bearing housing assembly 10, which can be configured to accommodate rotational movement of the solar panel during tracking operation. The bearing housing assembly 10 can be supported by the pivot plate 102 of the solar tracker interface 100 as previously described, such that loads can be transferred from the bearing housing assembly 10 to the solar tracker interface 100. The solar tracking system 200 can include a pair of foundation members 12, each of which can be configured to support the solar tracking system 200 relative to the surface. Loads associated with tracking can be transmitted through the bearing housing assembly 10, through the solar tracker interface 100, and to the pair of foundation members 12 and to a solar tracking system foundation (not shown). The solar tracking system 200 can further include the solar panel (not shown) coupled to the bearing housing assembly 10, such that movement of a bearing with the bearing housing assembly can correspond to movement of the solar panel.

In certain embodiments, the solar tracking system 200 can be assembled by coupling the pivot plate 102 to the bearing housing assembly 12. The top panel 106 of the pivot plate 102 can receive the bearing housing assembly 12 and be coupled using appropriate hardware, such as fasteners. The pair of brackets 104 can be coupled to the edge panels 108 of the pivot plate 102 through the mounting projections 120 and plurality of mounting apertures 146, which can permit relative angular positioning between the pivot plate 102 and each bracket 104.

The brackets 104 can be brought together such that the alignment lip 128 of one foundation plate 124 of bracket 104 can nest alongside the planar edge 130 of the corresponding foundation plate 124 of another bracket 104. The plurality of sixth apertures 136 disposed in the alignment lip 128 and the corresponding plurality of sixth apertures 136 in the opposing foundation plate 124 can be aligned. Fasteners extending through the aligned sixth apertures 136 can couple the nested foundation plates 124. This nesting and coupling arrangement can promote proper alignment of the brackets 104 and facilitate secure assembly.

Foundation members 12 can be positioned between the pair of foundation plates 124 of each bracket 104. The plurality of fourth apertures 132 and the plurality of fifth apertures 134 can receive fasteners to initially secure the foundation members 12 while permitting angular adjustment relative to the first fastener 138. After the brackets 104 and foundation members 12 are positioned, all fasteners can be tightened to couple the solar tracker interface 100. The combination of nesting between the alignment lips 128 and planar edges 130, the coupling through the sixth apertures 136, and the engagement features in the fifth apertures 134 can provide a rigid, structurally supported assembly. Additional angular adjustments of the pivot plate 102 relative to the mounting projection 120 can be made through the pivot and adjustment apertures 148, 150 as previously described, enabling fine-tuning of the orientation of the solar tracker interface 100 during installation.

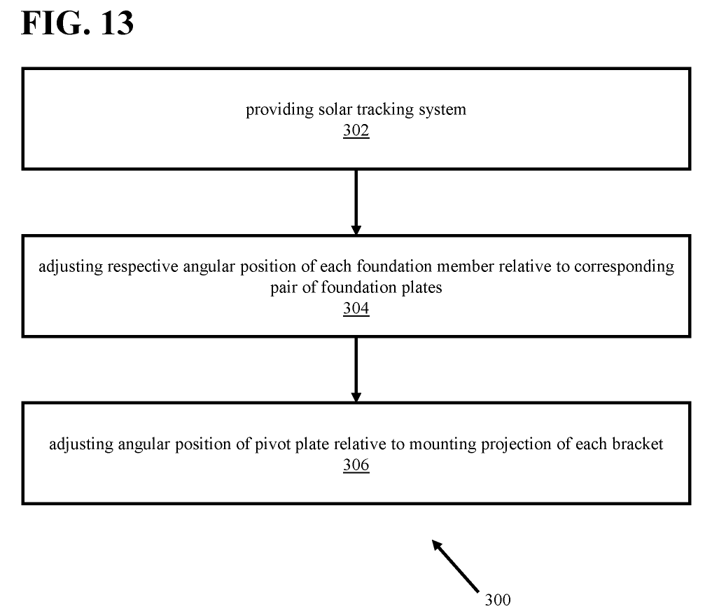

With reference to FIG. 13, in certain embodiments, a method 300 of installing a solar tracking system 200 is provided. The solar tracking system 200 can be configured as described hereinabove. The method 300 can be performed using components previously described and the method 300 can facilitate alignment and adjustment of the solar tracking system 200 during installation.

The method 300 can include providing the solar tracking system 200 as described herein. The solar tracking system 200 can include a solar tracker interface 100 and associated components arranged for installation. The method 300 can include adjusting a respective angular position of each foundation member 12 relative to a corresponding pair of foundation plates 124. Adjustment of each foundation member 12 can be permitted by cooperative interaction between the plurality of fourth apertures 132, the plurality of fifth apertures 134, and fasteners. The adjustment can enable alignment of the foundation members 12 relative to one another and to the bracket 104. The method 300 can include adjusting an angular position of the pivot plate 102 relative to the mounting projection 120 of each bracket 104 as described herein. The adjustment can be facilitated by interaction between the pivot aperture 148 and one or more adjustment apertures 180 described herein. Relative rotation between the pivot plate 102 and the mounting projection 120 can be permitted within a defined range. The adjusted angular position can correspond to a desired orientation of the solar tracking system 200. Following adjustment, the components of the solar tracking system 200 can be secured in their adjusted positions. Fasteners described herein can be used to maintain relative positions between components. Securing can militate against unintended movement during operation. The solar tracking system 200 can thereby be prepared for supporting solar tracking movement.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A solar tracker interface configured to receive a bearing housing assembly and a foundation member, comprising:
a pivot plate including a top panel and a pair of edge panels,
the top panel configured to receive the bearing housing assembly, and
the pair of edge panels extending from lateral edges of the top panel; and
a pair of brackets, each bracket including a central panel, a mounting projection, and a pair of foundation plates,
the mounting projection extending from a longitudinal end of the central panel,
the mounting projection configured to be attached to one of the edge panels of the pivot plate,
the pair of foundation plates extending from lateral edges of the central panel,
the pair of foundation plates configured to receive the foundation member therebetween, and
one of the foundation plates includes an alignment lip and the other one of the foundation plates includes a planar edge, the alignment lip providing a planar offset from a remainder of the foundation plate.

2. The solar tracker interface of claim 1, wherein the top panel and the pair of edge panels form a U-shaped cross-section.

3. The solar tracker interface of claim 1, wherein the pivot plate includes a plurality of first apertures, a plurality of second apertures, and a plurality of third apertures.

4. The solar tracker interface of claim 3, wherein the plurality of first apertures is disposed in the top panel and the plurality of second apertures and plurality of third apertures are disposed in the pair of edge panels.

5. The solar tracker interface of claim 1, wherein the central panel and the pair of foundation plates form a U-shaped cross-section.

6. The solar tracker interface of claim 1, wherein the pair of brackets includes a plurality of fourth apertures, a plurality of fifth apertures, and a plurality of sixth apertures.

7. The solar tracker interface of claim 6, wherein the plurality of fourth apertures is disposed in the pair of foundation plates adjacent to the longitudinal end of the central panel and configured to receive a first fastener extending through one of the plurality of fourth apertures and a corresponding aperture of the foundation member, the one of the plurality of fourth apertures permitting relative rotation of the foundation member about the first fastener.

8. The solar tracker interface of claim 7, wherein the plurality of fifth apertures is disposed in the pair of foundation plates adjacent another longitudinal end of the central panel.

9. The solar tracker interface of claim 8, wherein each fifth aperture of the plurality of fifth apertures includes a plurality of engagement features configured to militate against rotation of the foundation member about the first fastener.

10. The solar tracker interface of claim 9, wherein each fifth aperture has a longitudinal axis that is non-parallel to the lateral edges of the central panel.

11. The solar tracker interface of claim 10, wherein the plurality of engagement features comprise teeth formed along a portion of each fifth aperture of the plurality of fifth apertures.

12. The solar tracker interface of claim 11, wherein the plurality of sixth apertures is disposed in the in the alignment lip and the planar edge and configured to couple the pair of foundation plates.

13. The solar tracker interface of claim 1, wherein the mounting projection includes a plurality of mounting apertures.

14. The solar tracker interface of claim 13, wherein the plurality of mounting apertures includes a pivot aperture.

15. The solar tracker interface of claim 14, wherein the plurality of mounting apertures includes a pair of adjustment apertures, the pair of adjustment apertures cooperating to define a range of rotation of the pivot plate relative to the mounting projection.

16. The solar tracker interface of claim 1, wherein a plane of the central panel and a plane of the mounting projection form an obtuse angle.

17. A solar tracker interface configured to receive a bearing housing assembly and a foundation member, comprising:
a pivot plate including a top panel and a pair of edge panels,
the top panel configured to receive the bearing housing assembly, and
the pair of edge panels extending from lateral edges of the top panel; and
a pair of brackets, each bracket including a central panel, a mounting projection, and a pair of foundation plates,
the mounting projection extending from a longitudinal end of the central panel,
the mounting projection configured to be attached to one of the edge panels of the pivot plate,
the pair of foundation plates extending from lateral edges of the central panel,
the pair of foundation plates configured to receive the foundation member therebetween, and
one of the foundation plates includes an alignment lip and the other one of the foundation plates includes a planar edge, the alignment lip providing a planar offset from a remainder of the foundation plate,
wherein:
the pair of edge panels extend substantially parallel to each other,
the pair of edge panels extend substantially perpendicular to the top panel,
the top panel and the pair of edge panels form a U-shaped cross-section,
the pivot plate includes a plurality of first apertures, a plurality of second apertures, and a plurality of third apertures,
the plurality of first apertures is disposed in the top panel,
each first aperture of the plurality of first apertures is elongated,
each first aperture of the plurality of first apertures is stadium shaped,
the plurality of second apertures and plurality of third apertures are disposed in the pair of edge panels,
each second aperture of the plurality of second apertures is round,
each third aperture of the plurality of third apertures is square,
the pair of foundation plates extend substantially parallel to each other,
the pair of foundation plates extend substantially perpendicular to the central panel,
the central panel and the pair of foundation plates form a U-shaped cross-section,
the pair of brackets includes a plurality of fourth apertures, a plurality of fifth apertures, and a plurality of sixth apertures,
the plurality of fourth apertures is disposed in the pair of foundation plates adjacent to the longitudinal end of the central panel and configured to receive a first fastener extending through one of the plurality of fourth apertures and a corresponding aperture of the foundation member, the one of the plurality of fourth apertures permitting relative rotation of the foundation member about the first fastener,
the plurality of fifth apertures is disposed in the pair of foundation plates adjacent another longitudinal end of the central panel,
each fifth aperture of the plurality of fifth apertures is elongated,
each fifth aperture of the plurality of fifth apertures includes a plurality of engagement features configured to militate against rotation of the foundation member about the first fastener,
each fifth aperture has a longitudinal axis that is non-parallel to the lateral edges of the central panel,
the plurality of engagement features comprise teeth formed along a portion of each fifth aperture of the plurality of fifth apertures,
the plurality of sixth apertures is disposed in the alignment lip and the planar edge and configured to couple the pair of foundation plates,
a portion of the plurality of sixth apertures is disposed in the alignment lip,
the plurality of sixth apertures disposed in the alignment lip and the planar edge are coaxial,
the mounting projection includes a plurality of mounting apertures,
the plurality of mounting apertures includes a pivot aperture,
the plurality of mounting apertures further include a pair of adjustment apertures, the pair of adjustment apertures cooperating to define a range of rotation of the pivot plate relative to the mounting projection,
the pivot aperture and the pair of adjustment apertures form a linear array,
the adjustment apertures are disposed on opposite sides of the pivot aperture along the linear array,
each adjustment aperture of the pair of adjustment apertures has a kidney-shaped profile, and
a plane of the central panel and a plane of the mounting projection form an obtuse angle.

18. A solar tracking system, comprising:
a bearing housing assembly;
a pair of foundation members;
a pivot plate including a top panel and a pair of edge panels,
the top panel receiving the bearing housing assembly, and
the pair of edge panels extending from opposite edges of the top panel; and
a pair of brackets, each bracket including a central panel, a mounting projection, and a pair of foundation plates,
the mounting projection extending from a longitudinal end of the central panel,
the mounting projection attached to one of the edge panels of the pivot plate,
the pair of foundation plates extending from lateral edges of the central panel,
the pair of foundation plates receiving one of the foundation members therebetween,
one of the foundation plates includes an alignment lip and the other one of the foundation plates includes a planar edge, the alignment lip providing a planar offset from a remainder of the foundation plate, and
the alignment lip of each bracket is coupled to the planar edge of the other bracket.

19. The solar tracking system of claim 18, further comprising a solar panel coupled to the bearing housing assembly.

20. A method of installing a solar tracking system, comprising:
providing the solar tracking system of claim 18;
adjusting a respective angular position of each foundation member relative to the pair of foundation plates; and
adjusting an angular position of the pivot plate relative to the mounting projection of each bracket.
